(19) United States
(12) Patent Application Publication
(10) Pub. No.: US 2003/0083835 A1
(43) Pub. Date: May 1, 2003

(54) Image-autocrop method for calibrating image-input

(76) Inventor: Chung-Wei Cheng, Chu-Pei City (TW)

Correspondence Address: SUPREME PATENT SERVICES, POST OFFICE BOX 2339, SARATOGA, CA, 95070, US

(21) Appl. No.: 10/033,310

(22) Filed: Oct. 29, 2001

(51) Int. Cl. G06F 19/00

(52) U.S. Cl. 702/95

(57) ABSTRACT

An image-autocrop method is employed to calculate and calibrate the image data of a quadrangle of a target object scanned by an image-input device so as to acquire four optimum vertexes for defining a better image-autocrop field. This method is applied to load firstly the coordinates of four vertexes scanned, then calculate and calibrate them to obtain an optimum rectangular image scope.

### FIELD OF THE INVENTION

This method relates generally to an image processing method, particularly to an image-autocrop method for calibrating image-input device.

### BACKGROUND OF THE INVENTION

When a conventional image-input device, a scanner for example, is employed for input of image, the scanned target image is converted into digital data for further processing, and an operation flowchart thereof is shown in FIG. 1.

A step 10 is the step for an image-input device, a scanner for example, to scan a target and convert the scanned image into a digital image data stream. A step 11 is the step for the scanner to analyze the loaded digital image data to try locating some data cells and coordinates thereof in the image data stream that would define the boundaries of the target image. A step 13 is the step that takes advantage of the data cells obtained in the step 11 to thereby locate 4 data cells that could form a quadrangle covering the target image. Those 4 data cells are called 4 vertexes of the target image. A step 15 is the step for calculation of the inclination angle of the target image. A step 16 is the step for judging whether the inclination angle of the target image is 0 degrees or not, the procedure would go to a step 19 for image-autocrop if positive, otherwise, go to a step 17 for calibrating the image inclination. In the step 17, the inclination angle of the target image obtained according to the step 15 is swirled reversely until an image free of inclination is acquired. The step 19 is provided to autocrop the image boundaries from the scanned image based on data of those 4 vertexes confirmed or adjusted in the step 13.

However, in the case the background color of a target object, such as a photo, picture, positive or negative photograph, document, etc., approaches that of a lining plate inside an upper lid of the scanner, the step 11 may fail to locate the vertexes and define the boundaries of the target image accordingly, and neither can the step 15 calculate the inclination angle of the target image correctly, nor can the step 17 calibrate the inclination angle correctly, and furthermore, the autocrop accuracy in the step 19 is lowered and particularly worsened when the inclination angle of the target image is not “0” such that the error of image autocrop is enlarged if the inclination angle is beyond calibration. Under such a situation, labor's calibration would be required that, in fact, doesn't really help to an automatic scanning and cropping operation.

In view of abovesaid imperfection, after years of constant efforts in research, the inventor of this invention has consequently developed an image-autocrop method for calibrating image boundary to be described below.

### SUMMARY OF THE INVENTION

The primary object of this invention is to provide an image-autocrop method for calibrating image-input device, which can calibrate the input image boundaries of a target object without needing hand operation.

In order to realize abovesaid object, the image-autocrop method of this invention is employed to calculate and calibrate the image data of a quadrangle of a target object scanned by an image-input device so as to acquire four optimum vertexes for defining a better rectangular image-autocrop scope. The image-autocrop method comprises the following steps:

(A) Loading coordinate data of four scanned vertexes;

(B) Judging whether the quadrangle enclosed by those four vertexes is a rectangle or not, if positive, the procedure jumps to run step (E), or goes to step (C) otherwise;

(C) Judging whether the quadrangle has at least an inner right angle, if positive, the procedure goes to run step (D), or terminates the image-autocrop procedure otherwise;

(D) Drawing a line from a distal end of two line segments on sides of the inner right angle respectively and perpendicularly to form an intersection for joining to the rest three points or ends to serve as four optimum image vertexes; and

(E) Outputting coordinate data of those confirmed or adjusted four vertexes.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 shows an operation flowchart for image scan and autocrop of a conventional image-input device;

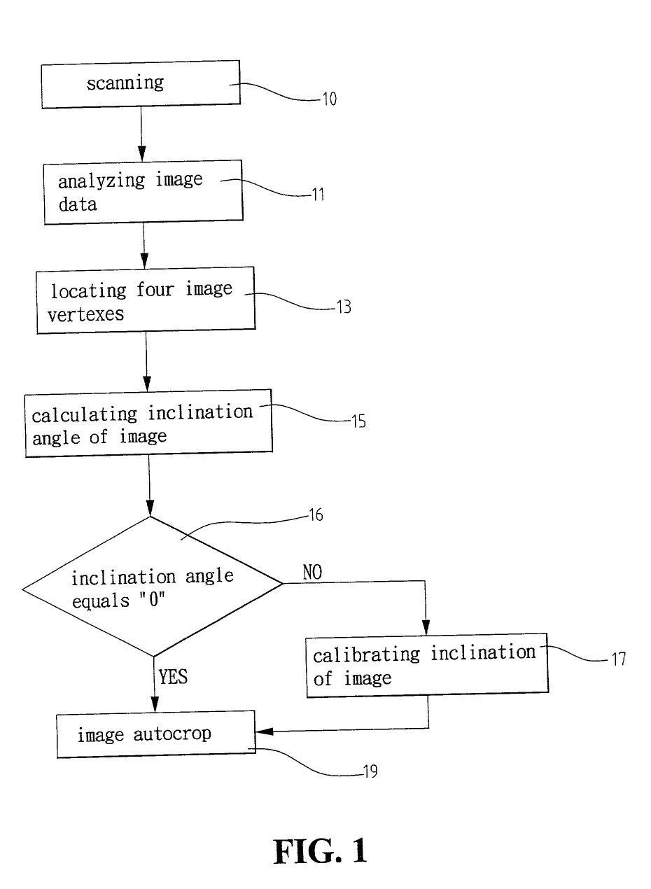

FIG. 2 shows an operation flowchart for image scan and autocrop of this invention;

FIG. 3 shows a target object of an embodiment of this invention; and

FIG. 4 shows an image-autocrop field calibrated by this invention when scanning the target object shown in FIG. 3.

### DETAILED DESCRIPTION OF THE INVENTION

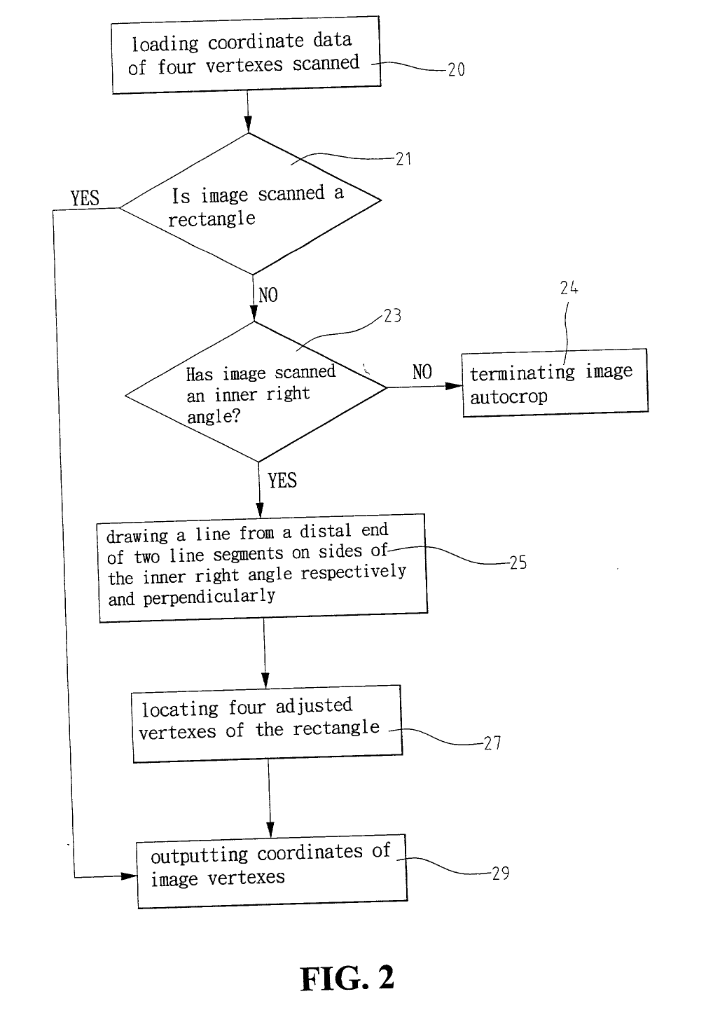

As shown in FIG. 2—an operation flowchart for image scan and autocrop of this invention, a step 20 is to load the coordinate data of four vertexes of a scanned image. A step 21 is to judge whether a quadrangle formed by connecting those four vertexes is a rectangle or not, if positive, the procedure then goes to run a step 29 for direct output of coordinate data of the confirmed four vertexes of the scanned image for image processing, otherwise it jumps to run a step 23 for judging whether the quadrangle contains an inner right angle or not, if positive, the procedure goes to run a step 25, otherwise it jumps to run a step 24 for stopping autocrop. The step 25 is to draw a line from a distal end of two contiguous side segments perpendicularly and respectively. A step 27 is to take the intersection of those two perpendicular lines as a new vertex to form totally four adjusted intersections with those two distal ends and the vertex at the inner right angle.

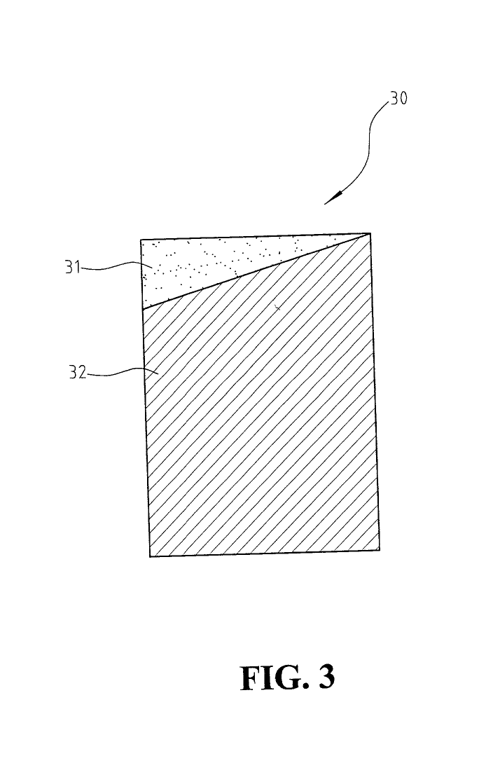

A target object 30 of an embodiment of this invention shown in FIG. 3 is a rectangular object, which is divided into block 31 and block 32, wherein color of the block 31 is distinct while that of the block 32 is indistinct from color of a lining plate of an upper lid of a scan device.

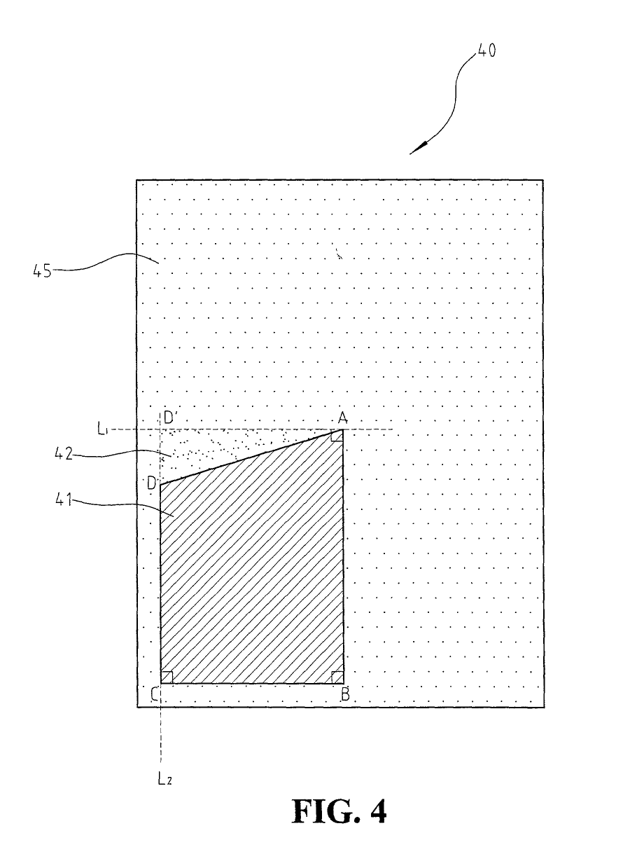

FIG. 4 shows an image-autocrop field calibrated by this invention when scanning the target object shown in FIG. 3. A scan covering section 40 is the maximum scan area of an image-input device, comprising: an image section 41, 42 (corresponding to the block 30, 31 respectively) created by a target object 30 and a background image section 45 of the inside lining plate of the upper lid in a scanner. The color of the block 32 and the lining plate of the upper lid of the scanner are about the same such that the scanner fails to discriminate the scanned image 42 of the block 32 from the background image 45 of the lining plate of the upper lid of the scanner.

The image section 41 of the block 31 is a target image section based on data cells of scanned image boundaries according to scanned data analyzed by the scanner, namely, four image vertexes A, B, C, D are loaded in foregoing step 20, and line segments AB, BC, CD, AD are boundaries of scan image that enclose a quadrangle covering the target image, i.e. the image section 41. At this time, the image section 42 is a part of image created by the target object 30 though, the scanner cannot discriminate the image section 42 from the background section 45 so that the scanner wouldn't take the image section 42 as part of the image of the target object 30.

In four inner angles of the quadrangle ABCD, angle B and angle C are right angles. From the vertexes A, C of the line segments AB, BC, straight lines L1, L2 perpendicular to the line segments AB, BC respectively are drawn and intersected at point D′ serving as a new vertex for scanning instead of point D. By doing so, point A, B, C, and D′ become the calibrated image vertexes enclosing a quadrangle ABCD′ that covers the image created by the target object 30, including the image section 41, 42.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. An image-autocrop method for calibrating image-input device, which is employed to calculate image data of a quadrangle of a target object scanned by an image-input device so as to acquire four optimum vertexes for defining a better rectangular image-autocrop scope, the method comprising:
loading coordinate data of four vertexes scanned;
judging whether the quadrangle enclosed by those four vertexes is a rectangle or not, if positive, the procedure jumps to run last step, otherwise, goes to next step;
judging whether the quadrangle has at least an inner right angle, if positive, the procedure goes to run next step, otherwise, terminates the image-autocrop procedure;
drawing a line from a distal end of two line segments on sides of the inner right angle respectively and perpendicularly to form an intersection for joining to the rest three points or ends to serve as four optimum image vertexes; and
outputting coordinate data of those confirmed or adjusted four vertexes.

2. The method according to claim 1, wherein the image-input device is an image scanner.

3. The method according to claim 1, further comprising a step for editing the operation program.
